(19) United States
(12) Patent Application Publication
(10) Pub. No.: US 2003/0121048 A1
(43) Pub. Date: Jun. 26, 2003

(54) Broadcast channel link server and method therefor

(76) Inventor: Johney Hwang, Seoul (KR)

Correspondence Address: HARNESS, DICKEY & PIERCE, P.L.C., P.O. BOX 8910, RESTON, VA, 20195, US

(21) Appl. No.: 10/181,567

(22) PCT Filed: Dec. 29, 2000
(86) PCT No.: PCT/KR00/01560

(51) Int. Cl. H04N 7/16; H04N 7/173

(52) U.S. Cl. 725/93; 725/8; 725/91; 725/115; 725/116

(57) ABSTRACT

The present invention relates to a broadcast channel link server and method therefore. In particular, the present invention relates to a broadcast channel link server for providing a selected broadcast program in a predetermined period of time for free-charge when a client selects the broadcast program of charged Internet broadcasts in an Internet site which provides broadcast search and display services, so as to promote the client's interests and derive the client to register as a member of the charged broadcast site to make more profits by a corresponding site entrepreneur.

A method of broadcast channel link in an Internet broadcast service system of the invention comprises the steps of: a) checking whether an Internet broadcast channel requested(selected) by the client terminal through the Internet broadcast channel search site is for charged or free; b) checking whether a client is a member of the selected Internet broadcast channel by using user information in the client terminal in case the selected Internet broadcast channel is for charged as a result of the step a); and c)

linking the selected charged Internet broadcast channel in a predetermined period of time in case the client is not a member of the selected Internet broadcast channel as a result of the step b), and providing a program of the charged Internet broadcast channel to the client terminal.

### TECHNICAL FIELD

The present invention relates to a broadcast channel link server and method therefore. In particular, the present invention relates to a broadcast channel link server for providing a selected broadcast program in a predetermined period of time for free-charge when a client selects the broadcast program of charged Internet broadcasts in an Internet site which provides broadcast search and display services, so as to promote the client's interests and derive the client to register as a member of the charged broadcast site to make more profits by a corresponding site entrepreneur.

### BACKGROUND ART

When a client wants to view various Internet broadcast programs in the Internet, the client should repeat some tedious steps, such as connect, move and re-connect to a corresponding broadcast site.

Nowadays, an Internet site (hereinafter, it is called broadcast channel search site) providing various services, such as channel searching, reservation and provision of broadcast information, turns up in a form of an integrated TV search program and an integrated display software, such that the client can easily watch various programs broadcasting in a plurality of channels in the Internet site. It would be very useful for the client who wants to enjoy the Internet TV broadcast programs easily and diversely.

However, the client cannot get the service of the selected broadcast program in case the client is not a member of the corresponding charged broadcast site when the client selects a charged broadcast program in such a broadcast channel search site.

The entrepreneurs managing Internet sites in the Internet are seeking various ways to make more profits. In view of such efforts, a method to lead more clients to register as a member of the corresponding charged broadcast when the client selects the charged broadcast in the broadcast channel search site, in order to get more profits.

### DISCLOSURE OF INVENTION

Therefore, the present invention is designed to overcome the above problems. It is an object of the present invention to provide a broadcast channel link server and method therefore, wherein when a client selects a charged Internet broadcast in an Internet broadcast channel search site which provides a TV broadcast program search and display service, the broadcast channel link server provides the selected broadcast program for free-charge in a predetermined period of time in order to creat the client's interests, then restricts the broadcast to inform that the broadcast site is for charged, and then derives the client to register as a member of the charged broadcast site such that a provider of the corresponding site may get more profits.

In order to accomplish the above object, one embodiment of the invention provides a broadcast channel link server in an Internet broadcast service system including a web server for 1) managing an Internet broadcast channel search site which provides a broadcast program corresponding to a charged/free Internet broadcast channel through a computer network which can be connected by at least one client terminal, and 2) providing the broadcast program of the corresponding Internet broadcast channel requested by the client terminal on the computer network through the Internet broadcast channel search site, the broadcast channel link server comprising: a) a link control module for checking whether the Internet broadcast channel requested(selected) by the client terminal is for charged and whether a client of the client terminal is a member of the selected Internet broadcast channel and determining whether to provide the broadcast program of the selected charged Internet broadcast channel continuously or in a predetermined period of time according to a checked result; and b) a channel link module for linking the requested Internet broadcast channel according to the determination of the link control module and providing the broadcast program of the Internet broadcast channel to the client terminal through the Internet broadcast channel search site.

In order to accomplish the object, another embodiment of the invention provides a method of broadcast channel link in an Internet broadcast service system for 1) managing an Internet broadcast channel search site which provides a broadcast program corresponding to a charged/free Internet broadcast channel through a computer network which can be connected by at least one client terminal, and 2) providing the Internet broadcast channel requested by the client terminal on the network, the method comprising the steps of:

a) checking whether an Internet broadcast channel requested(selected) by the client terminal through the Internet broadcast channel search site is for charged or free;

b) checking whether a client is a member of the selected Internet broadcast channel by using user information in the client terminal in case the selected Internet broadcast channel is for charged as a result of the step a);

c) linking the selected charged Internet broadcast channel in a predetermined period of time in case the client is not a member of the selected Internet broadcast channel as a result of the step b), and providing a program of the charged Internet broadcast channel to the client terminal.

d) providing a registration procedure for the client to be a member of the selected charged channel in case the client is not a member of the selected Internet broadcast channel, and determining whether to register the client as a member of the selected charged Internet broadcast channel according to a registration request signal by the client; and

e) giving an opportunity for the client to select payment method for the service rate of the Internet broadcast channel, and providing the program of the charged Internet broadcast channel to the client terminal in response to a signal to select the payment method from the client in case the client is a member of the charged Internet broadcast channel, as a result of the step b).

In yet another embodiment of the invention, the step c) further includes a step of providing a message to inform that the selected Internet broadcast channel is for charged, and the step d) further includes a step of retrieving the registration procedure to be a member of the selected Internet broadcast channel from the site which provides the requested charged Internet broadcast channel, and providing the registration procedure to the client terminal through the Internet broadcast channel search site in case the client requests membership, as a registration to be a member of the selected charged channel is given.

In still another embodiment of the invention, the step e) further includes a step of providing information on a flat sum system which charges fixed amount for a predetermined period of time and a method for charging the service rate per access hour as the payment method such that the client can select one for the methods, and setting the method selected by the client as the payment method for the charged Internet broadcast channel, a step of providing information on the payment methods for the service rate with a prepaid card, with an electronic money which is available in Internet, a charged telephone service, or a payment method for imposing the service rate on the bill of the personal mobile phone such that the client selects one of the payment methods, and setting the method selected by the client as the payment method for the charged Internet broadcast channel, and a step of requesting or charging commission or corresponding value predetermined by an agreement and certification with a provider of the selected charged Internet broadcast channel, according to the payment method selected by the client.

### BRIEF DESCRIPTION OF THE DRAWINGS

These and other features, aspects, and advantages of the present invention will help for better understanding with regard to the following description, appended claims, and accompanying drawings, in which like components are referred to by like reference numerals. In the drawings:

FIG. 1 is a block diagram for illustrating flows of a broadcast service in accordance with the present invention; and

FIG. 2 is a flow chart for illustrating a service of a broadcast channel link server in accordance with the present invention.

### BEST MODE FOR CARRYING OUT THE INVENTION

Hereinafter, preferred embodiments of the present invention will be described in detail with reference to the accompanying drawings.

In order to realize the present invention, a client should register as a member of a broadcast channel search site, and have a device which enables the client to make use of various services of the broadcast channel search site. The device may be a PC which provides Internet communications, a TV having an Internet set-top box or a digital TV, hereinafter, it is called a client terminal.

Moreover, in order to realize the invention, a broadcast link system including a web server and a broadcast link server should be configured. The web server manages the broadcast channel search site which enables a client to search or watch the TV broadcast program. And, the broadcast link server links a selected broadcast when the client selects a broadcast program in the broadcast channel search site.

When the client selects a charged broadcast in the broadcast channel search site, the web server checks client information, and determines whether the client is a member of the charged broadcast or not. Then, the web server provides the checked information to the broadcast link server. It is preferable for the information to include a database for managing the information of the members.

The broadcast link server is loaded with an application programmed to provide a selected broadcast to the client terminal in a predetermined period of time if a charged broadcast is selected in the broadcast channel search site, then, to give an opportunity to register as a member of the charged broadcast, and to provide the charged broadcast to the client who registered as a member of the charged broadcast.

The broadcast link server loaded with the application, not shown in the figure, can include a channel link module, a display module and a link control module. The channel link module, when the client selects a charged broadcast in the broadcast channel search site, provides the selected broadcast to the client terminal in a predetermined period of time and restricts the charged broadcast. The display module generates information to notify the client that the selected broadcast is for charged and transmits the information to the client terminal. And, a link control module provides an opportunity to register as a member of the selected broadcast to the client and to select a payment method if the client registers as a member of the selected broadcast, and provides the charged broadcast to the client according to the selected payment method.

In addition, the link control module determines whether the client is the member of the charged broadcast with reference to the database pre-constructed in the web server when the client selects the charged broadcast. If the client is the member of the charged broadcast, the link control module provides the selected broadcast to the client terminal without any restriction, in view of the predetermined payment method of the rate.

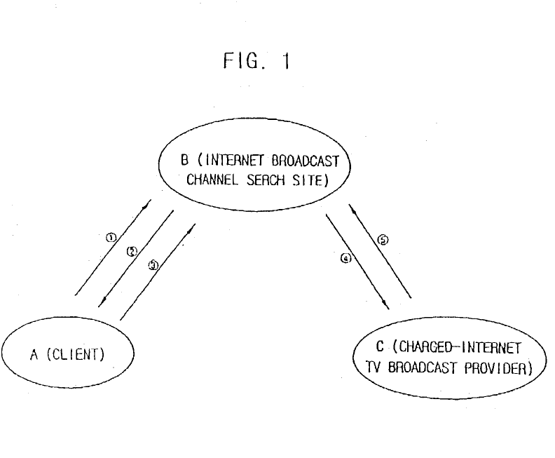

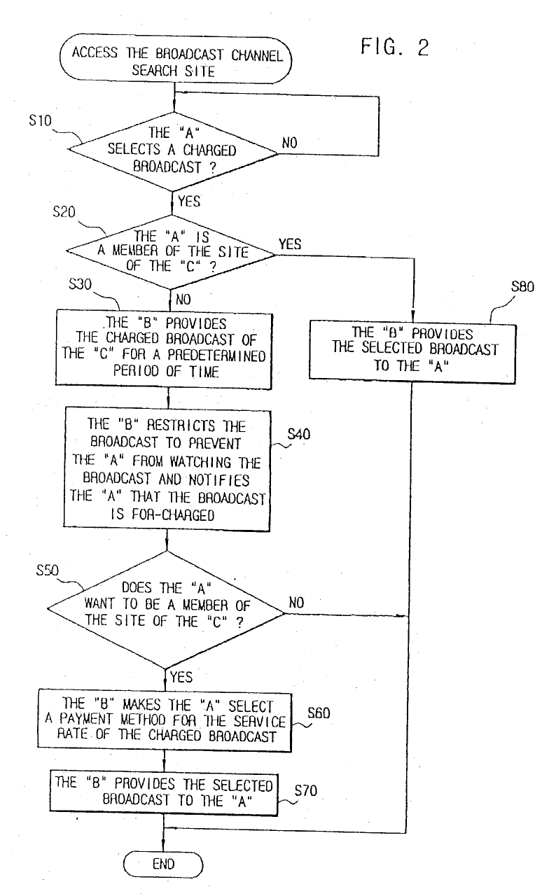

FIG. 1 shows flows of a service proceed in accordance with the present invention. When the client (hereinafter, “A”) accesses a broadcast channel search site (hereinafter, “B”) via a client terminal and accesses a charged broadcast provided by a charged Internet TV provider (hereinafter, “C”) while making use of the B's services \mathring{1}. Then, the B provides the charged broadcast for free-charge in a predetermined period of time agreed with the C, then and prevents the A from watching the charged broadcast any further by restricting the broadcast, and notifies the client that the broadcast is for charged \mathring{2}. If A registers as a member of a site of C after giving an opportunity to be a member of the charged broadcast \mathring{3}, the B shares the information of A with the C \mathring{4}. The B makes A watch continuously the charged broadcast provided by the C, and the C pays the B commission for the membership registration of A \mathring{5}. It means that B and C share the profits from the commission. Now, the present invention will be described in detail, with reference to the FIG. 2.

At first, the B determines whether the A is a member of the site of the C if the A selects the charged broadcast managed by the C after accessing the site of the B, in steps S10 and S20.

If the B determines that the A is not a member of the site of the C, the B provides the charged broadcast of the C for a predetermined period of time agreed with the C S30 for free. After that, the B restricts the broadcast to prevent the A from watching the broadcast and notifies the A that the broadcast service of the C is for charged S40.

Then, the B gives an opportunity for the A to register as a member of the site of the C such that the A can take the service of the C in S50 continuously. If the A wants to register as a member of the site of the C, the B makes the A select a payment method for the service rate of the charged broadcast S60.

The payment method for the service rate of the charged broadcast includes a flat sum system which charges fixed amount for a predetermined period of time, a method for charging the service rate per access hour, a payment method with a prepaid card or an electronic money which is available in Internet, a charged telephone service, or a payment method for imposing the service rate on the bill of the personal mobile phone. The B and C share the profits on the basis of the agreement therebetween according to the payment method selected by the A.

Where, if the client pays the service rate with the prepaid card, the broadcast link server includes a module for recognizing a card number inputted through the client terminal and a module for determining validity of the corresponding card.

If the client pays the service rate through the charged telephone service, the B and a charged telephone service provider (for example, Korea Telecom Co, etc) should have a contract for the payment and receipt of the service rate of the charged broadcast. If the A pays through the charged telephone service, for example, the service rate is charged on the hour-basis. The service rate is imposed automatically on the owner of the corresponding phone number and is billed along with the telephone charges. In this case, the charged telephone service provider, B and C may share the profits according to the contract.

Alternately if the A wants to watch the broadcast, the A calls the charged telephone service provider to acquire an ID number for watching the charged broadcast and can watch the charged broadcast. In this case, the A can watch the charged broadcast as much as the service rate assigned to the ID number. The service rate is also imposed automatically on the owner of the corresponding phone number and is billed along with the telephone charges, likewise.

The registration of a member of the charged broadcast can be carried out by transmitting the registration information from the B to the site of the C, if the A registers as a member according to a registration form transmitted from the site of the C to the B. In addition, if A registers as a member of the charged broadcast when the A is given the opportunity for membership registration, the B connects the A to the registration site of the C in order for the A to be a member.

In the present invention, the “member” includes all the members who pay the service rate of the charged broadcast through the payment methods described above.

If the A becomes a member after the steps S50 and S60 and selects a payment method for the charged broadcast, the B shares the information of the A with the C and causes the broadcast selected by the A to be provided continuously according to the payment method S70.

For example, if the A wants to watch the charged broadcast for only some periods of time with the prepaid card, the B restricts the charged broadcast after the specified time paid off with the prepaid card so as not to be watched any further.

In the mean while, if the B determines that the A is a member of the charged broadcast in the step 20, the B provides continuously the charged broadcast service selected by the A so as to watch the broadcast without any inconvenience S80. At this time, the B controls the services of the site of the C according to payment method of the A for the service rate. For example, if the A is a member of the C in a flat sum system (for example, monthly-basis), the B shares the information of the A with the C so that the A can watch a desired broadcast program of the C on the site of the B without any restriction.

As described above, the present invention gives advantages as follows.

First, the client can watch a charged Internet TV program for free in a predetermined period of time in a broadcast channel search site. So the client can acquire information of the corresponding channel, the provider of the charged broadcast site can draw more members of the site. Accordingly, the provider of the broadcast channel search site can provide various channel services and get advertising effect.

Second, the client who uses various charged Internet TV channels can easily access a desired broadcast in the broadcast channel search site as well as easily get other broadcast search and watch services, without any inconvenience of separate access in each site.

Third, if the number of companies associated with the provider of the broadcast channel search site is increased, the client can get the better the quality of the service and the more abundant contents. In addition, it is possible to minimize the unexpected loss due to the accidental leakage of personal information.

Firth, other related providers can cooperate one another to draw more members and to do various businesses, such as advertisement.

The broadcast channel link server and method thereof according to the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A broadcast channel link server in an Internet broadcast service system including a web server for 1) managing an Internet broadcast channel search site which provides a broadcast program corresponding to a charged/free Internet broadcast channel through a computer network which can be connected by at least one client terminal, and 2) providing the broadcast program of the corresponding Internet broadcast channel requested by the client terminal on the computer network through the Internet broadcast channel search site, the broadcast channel link server comprising:
a) a link control module for checking whether the Internet broadcast channel requested(selected) by the client terminal is for charged and whether a client of the client terminal is a member of the selected Internet broadcast channel and determining whether to provide the broadcast program of the selected charged Internet broadcast channel continuously or in a predetermined period of time according to a checked result; and
b) a channel link module for linking the requested Internet broadcast channel according to the determination of the link control module and providing the broadcast program of the Internet broadcast channel to the client terminal through the Internet broadcast channel search site.

2. The broadcast channel link server as claimed in claim 1, wherein the broadcast channel link server further comprises c) a message module for generating a message to inform that the requested Internet broadcast channel is for charged and providing the message to the Internet broadcast channel search site in case that the requested Internet broadcast channel is for charged, according to the determination of the link control module.

3. The broadcast channel link server as claimed in claim 1, wherein the link control module provides a registration procedure for a client to be a member of the selected charged Internet broadcast channel if the client is not a member of the selected Internet broadcast channel and determines whether to register the client as the member of the selected Internet broadcast channel according to a registration request signal by the client.

4. The broadcast channel link server as claimed in claim 3, wherein the link control module retrieves the registration procedure to be a member of the selected Internet broadcast channel from the site providing the requested charged Internet broadcast channel and provides the registration procedure to the client terminal through the Internet broadcast channel search site in case the client requests membership.

5. A method of broadcast channel link in an Internet broadcast service system for 1) managing an Internet broadcast channel search site which provides a broadcast program corresponding to a charged/free Internet broadcast channel through a computer network which can be connected by at least one client terminal, and 2) providing the Internet broadcast channel requested by the client terminal on the network, the method comprising the steps of:
a) checking whether an Internet broadcast channel requested(selected) by the client terminal through the Internet broadcast channel search site is for charged or free;
b) checking whether a client is a member of the selected Internet broadcast channel by using user information in the client terminal in case the selected Internet broadcast channel is for charged as a result of the step a); and
c) linking the selected charged Internet broadcast channel in a predetermined period of time in case the client is not a member of the selected Internet broadcast channel as a result of the step b), and providing a program of the charged Internet broadcast channel to the client terminal.

6. The method for broadcast channel link as claimed in claim 5, wherein the step c) further includes a step of providing a message to inform that the selected Internet broadcast channel is for charged.

7. The method for broadcast channel link as claimed in claim 5, further comprising a step d) for providing a registration procedure for the client to be a member of the selected charged channel in case the client is not a member of the selected Internet broadcast channel, and determining whether to register the client as a member of the selected charged Internet broadcast channel according to a registration request signal by the client.

8. The method for broadcast channel link as claimed in claim 7, wherein the step d) further includes a step of retrieving the registration procedure to be a member of the selected Internet broadcast channel from the site which provides the requested charged Internet broadcast channel, and providing the registration procedure to the client terminal through the Internet broadcast channel search site in case the client requests membership, as a registration to be a member of the selected charged channel is given.

9. The method for broadcast channel link as claimed in claim 5, further comprising a step e) of giving an opportunity for the client to select payment method for the service rate of the Internet broadcast channel, and providing the program of the charged Internet broadcast channel to the client terminal in response to a signal to select the payment method from the client in case the client is a member of the charged Internet broadcast channel, as a result of the step b).

10. The method for broadcast channel link as claimed in claim 9, wherein the step e) further includes a step of providing information on a flat sum system which charges fixed amount for a predetermined period of time and a method for charging the service rate per access hour as the payment method such that the client can select one for the methods, and setting the method selected by the client as the payment method for the charged Internet broadcast channel.

11. The method for broadcast channel link as claimed in claim 9, wherein the step e) further includes a step of providing information on the payment methods for the service rate with a prepaid card, with an electronic money which is available in Internet, a charged telephone service, or a payment method for imposing the service rate on the bill of the personal mobile phone such that the client selects one of the payment methods, and setting the method selected by the client as the payment method for the charged Internet broadcast channel.

12. The method for broadcast channel link as claimed in claim 9. wherein the step e) further includes a step of requesting or charging commission or corresponding value predetermined by an agreement and certification with a provider of the selected charged Internet broadcast channel, according to the payment method selected by the client.
